(19) United States
(12) Patent Application Publication
(10) Pub. No.: US 2007/0098162 A1
(43) Pub. Date: May 3, 2007

(54) Method and apparatus for managing rights of multi-layered multimedia stream by layers

(75) Inventor: Sung-chol Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/582,488

(22) Filed: Oct. 18, 2006

(30) Foreign Application Priority Data
Oct. 27, 2005 (KR) 10-2005-0101965

(51) Int. Cl. H04N 7/167

(52) U.S. Cl. 380/201

(57) ABSTRACT

A method and apparatus capable of managing the rights of multi-layered video bitstreams by layers are provided. The method includes generating a scalable bitstream from an input video, the scalable bitstream having a plurality of layers of data; generating encryption keys, each encryption key corresponding to a respective one of the layers; and generating an encrypted scalable bitstream by encrypting each layer of data by means of the encryption key corresponding to the layer. The apparatus includes a scalable video encoder which generates a scalable bitstream by using an input video, the scalable bitstream having a plurality of layer data; a license generating unit which generates encryption keys, each of the encryption keys corresponding to a respective one of the plurality of layers; and an encrypting unit which generates an encrypted scalable bitstream by encrypting the layer data corresponding to the respective encryption keys using the corresponding encryption keys.

### CROSS-REFERENCE TO RELATED APPLICATION

This application claims priority from Korean Patent Application No. 10-2005-0101965 filed on Oct. 27, 2005 in the Korean Intellectual Property Office, the disclosure of which is incorporated herein by reference in its entirety.

### BACKGROUND OF THE INVENTION

1. Field of the Invention

Methods and apparatuses consistent with the present invention relate to managing the rights of digital multimedia, and more particularly, to managing the rights of multi-layered video bitstreams by layers.

2. Description of the Related Art

With the development of information communication technology including the Internet, video communication as well as text and voice communication has been increasing. Since conventional text communication cannot satisfy various demands of users, demands for multimedia services that can provide various types of information such as text, pictures, and music have increased. Multimedia data requires a large-capacity storage medium and a wide bandwidth for transmission since the amount of multimedia data is usually large. For example, a 24-bit true color image having a resolution of 640 * 480 needs a capacity of 640 * 480 * 24 bits, i.e., data of about 7.37 Mbits, per frame. When this image is transmitted at a speed of 30 frames per second, a bandwidth of 221 Mbits/sec is required, and when a 90-minute movie based on the image is stored, a storage space of about 1200 Gbits is required. Accordingly, a compression coding method is a requisite for transmitting the multimedia data including text, video, and audio.

Different types of transmission media for multimedia have different performance. Transmission media that are currently used have various transmission rates. For example, an ultrahigh-speed communication network can transmit data of several tens of megabits per second while a mobile communication network has a transmission rate of 384 kilobits per second. Further, terminal devices capable of receiving and playing the multimedia data includes devices having different transmission rates, such as a large-scale computer, a personal computer, a DVD player, a PDA, a mobile phone, or other such devices, of which performances are significantly different from one another.

Accordingly, a scalable video coding technology is currently under development in order to easily obtain various bitstreams, of which resolution, frame rate, or image quality can be adjusted, from one video bitstream in correspondence with varying environment and transmission rate needs. In particular, scalable video coding based on the H.264 CODEC is being standardized by a Joint Video Team (JVT), which is a joint group between Motion Picture Experts Group (MPEG) and International Telecommunication Union (ITU).

On the other hand, a digital rights management (hereinafter, referred to as “DRM”) technology for multimedia is becoming popular in protecting an intellectual property of a producer who has created media contents. Since the DRM technology plays an important role in protecting multimedia contents which are protected by copyrights, such as music or a movie, or other similar media, demands for the DRM service have been increasing in the market.

Ideally, a multimedia encryption algorithm has high security, low complexity, low compression overhead, error flexibility, and random play capability. The security is a requisite for the multimedia encryption. The multimedia encryption is characterized in that, for example, the amount of video data to be encrypted is relatively large and the value of encrypted information is generally low as compared with other types of encryption for military or financial applications.

A predetermined encryption process or decrypting process requires unnecessary processing overhead, and accordingly, low complexity is an important issue. Since a multimedia stream has a relatively large amount of data, low complexity is advantageous, and may even be required, for some applications.

Further, the encryption overhead is also an issue because the encryption reduces a coding efficiency of the compression algorithm or inevitably affects the compression efficiency by adding bytes in a file that has been already compressed. In this case, it would be ideal if the compression overhead would be minimized for the multimedia encryption algorithm.

In recent years, many algorithms considering the characteristics of the multimedia encryption have been proposed. However, these algorithms have been applied with respect to various rights (for example, read, copy, or retransmission) on one content. However, as described above, the scalable bitstream is characterized in that an image having a higher quality is provided as being closer to an upper layer of a plurality of layers. Therefore, it is necessary to encrypt the scalable bitstream by layers and to grant a right to decrypt only a corresponding layer according to a license right of a terminal device.

### SUMMARY OF THE INVENTION

An aspect of the present invention is to provide a method and apparatus for controlling multimedia contents by granting an independent license for each layer of a multi-layered multimedia stream.

However, the aspects of the present invention are not limited to those mentioned above, and other aspects of the present invention will be understood by those skilled in the art through the following description.

In order to achieve the above and other aspects, there is provided a method of encrypting data by layers, the method includes generating a scalable bitstream from an input video, the scalable bitstream having a plurality of layers of data; generating a plurality of encryption keys, each encryption key corresponding to a respective one of the layers; and generating an encrypted scalable bitstream by encrypting each layer of data by means of the encryption key corresponding to the layer.

Further, according to another aspect of the present invention, there is provided a method of decrypting data by layers, the method including receiving an encrypted scalable bitstream; analyzing a license so as to extract a decryption key corresponding to at least one layer included in the license; decrypting data, which belongs to a layer corresponding to the extracted decryption key, of the encrypted scalable bitstream using the extracted decryption key; and decoding the decrypted bitstream including the decrypted layers.

Furthermore, according to still another aspect of the present invention, there is provided an apparatus for encrypting data by layers, the apparatus including a scalable video encoder which generates a scalable bitstream by using an input video, the scalable bitstream having a plurality of layer data; a license generating unit which generates a plurality of encryption keys, each of the encryption keys corresponding to a respective one of the plurality of layers; and an encrypting unit which generates an encrypted scalable bitstream by encrypting the layer data corresponding to the respective encryption keys by means of the corresponding encryption keys.

In addition, according to still another aspect of the present invention, there is provided an apparatus for decrypting data by layers, the apparatus including a contents receiving unit which receives an encrypted scalable bitstream; a license analysis unit which analyzes a license so as to extract a decryption key corresponding to at least one layer included in the license; a decrypting unit which decrypts data, which belongs to a layer corresponding to the extracted decryption key, of the encrypted scalable bitstream using the extracted decryption key; and a scalable video decoder which decodes the decrypted bitstream including the decrypted layer.

### BRIEF DESCRIPTION OF THE DRAWINGS

The above and other aspects of the present invention will become more apparent by describing in detail certain exemplary embodiments thereof with reference to the attached drawings, in which:

FIG. 1 is a view illustrating a structure of a digital rights management system according to an exemplary embodiment of the present invention;

FIG. 2 is a view illustrating the configuration of a scalable video encoder according to an exemplary embodiment of the present invention;

FIG. 3 is a view illustrating the configuration of a scalable bitstream according to an exemplary embodiment of the present invention;

FIG. 4 is a view illustrating the configuration of each layer data of the scalable bitstream shown in FIG. 3;

FIG. 5 is a view schematically illustrating a process in which an encrypted bitstream is decrypted by various contents playing devices;

FIG. 6 is a view illustrating the configuration of a scalable video decoder; and

FIG. 7 is a flow chart illustrating overall operations of an exemplary embodiment of the present invention.

### DETAILED DESCRIPTION OF EXEMPLARY EMBODIMENTS OF THE PRESENT INVENTION

Advantages and features of the present invention and methods of accomplishing the same may be understood more readily by reference to the following detailed description of exemplary embodiments and the accompanying drawings. The present inventive concept may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present inventive concept will now be described more fully with reference to the accompanying drawings, in which exemplary embodiments of the invention are shown.

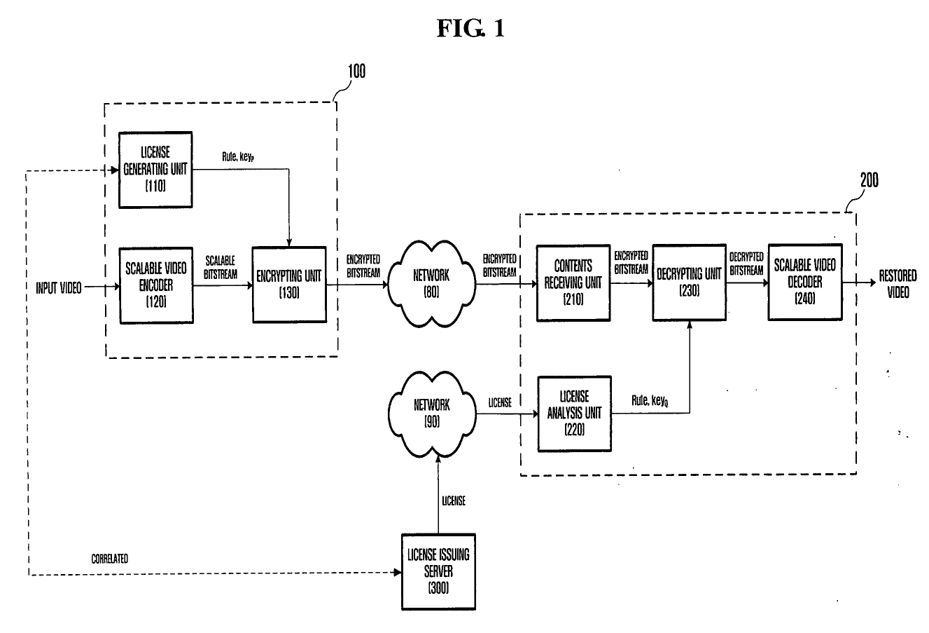

FIG. 1 is a view illustrating the entire structure of a digital rights management system according to an exemplary embodiment of the present invention. The digital rights management system includes a contents generating device 100, a contents playing device 200, and a license issuing server 300.

The contents generating device 100 generates a scalable bitstream by using an input original video and encrypts the scalable bitstream by respective data layers, which form the scalable bitstream, by using an encryption key set keyₚ according to rules, denoted “Rule” in the figure, which may be predetermined, thereby generating an encrypted bitstream. In order to do so, the contents generating device 100 includes a license generating unit 110, a scalable video encoder 120, and an encrypting unit 130.

The license generating unit 200 generates rules to be applied to the entire video contents and the encryption key set keyₚ to be applied for the respective layer data. The rules denote rights applied to contents. The contents may be predetermined. In the case of video contents, the rules denote rights granted according to various operations, such as reading contents, reading contents for a period of time, reading contents within a number of times, and retransmission of contents. The period of time and the number of times may both be predetermined. For example, an encryption key to which a right capable of reading contents once is granted can make corresponding contents played back only once, and an encryption key to which a right capable of reading contents once is granted for two hours can make corresponding contents played back for two hours. Therefore, according to exemplary embodiments of the present invention, encryption keys (i.e., the encryption key set) corresponding to the number of layers independently exist with respect to one rule because an encryption key independently exists for each of the layers forming one content, even though it is general that one corresponding encryption key exists for one rule.

In addition, the license generating unit 200 generates a decryption key corresponding to the encryption key. In the public-key infrastructure (PKI) algorithm that is generally used, a pair of keys including a public-key-type encryption key and a private-key-type decryption key are created, and data is encrypted by using the encryption key and then the encrypted data is decrypted by using the private key. This type of algorithm is called asymmetrical encryption, and the algorithm is based on a principle that it is difficult to inversely calculate two large prime numbers from a number which is a product of the two large prime numbers. Therefore, even though a third party to whom data encrypted by a public key is transmitted finds out the public key from the data, there is little possibility of encrypting the data with the public key. That is, in the asymmetrical encryption method, the data encrypted by the public key can be decrypted only by a secret key which forms a pair of keys together with the public key.

However, a key creation method of the present invention is not limited to the asymmetrical method. For example, a symmetrical encryption method may be used. In the case of using a symmetrical key, an encryption key and a decryption key are equal to each other. Accordingly, if a third party finds out an encryption key from encrypted data, the encrypted data can be decrypted by the encryption key. Thus, in terms of the security, the symmetrical encryption method may be a little worse than the asymmetrical encryption method.

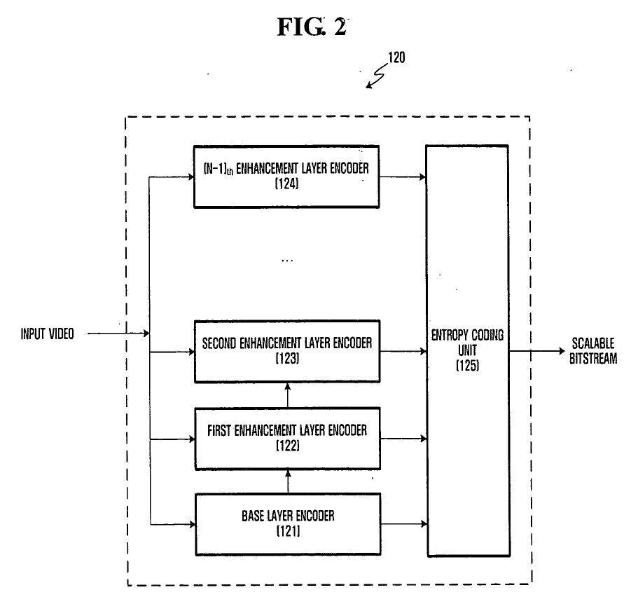

The scalable video encoder 120 generates a scalable bitstream by using an input video (i.e., an original video). A detailed configuration of the scalable video encoder 120 is shown in FIG. 2.

The scalable video encoder 120 includes a number (N) of encoders 121, 122, 123, and 124, which create respective layer data by using an input video, and an entropy coding unit 125 that losslessly encodes the respective layer data. The number (N) of encoders may be predetermined.

First, an operation performed by the base layer encoder 121 will be described.

An input video picture is down-sampled in a spatial and/or temporal manner. Then, a motion estimation process is performed for the down-sampled video picture. The motion estimation process is a process of finding a motion vector with respect to a current picture by referring to neighboring reference pictures. In general, in order to perform the motion estimation, a block matching algorithm is widely used. However, other similar algorithms may also be used.

Thereafter, motion compensation for the reference picture is performed by using the obtained motion vector, thereby generating an estimated picture with respect to the current picture. Then, a residual signal is obtained by using a difference between the current picture and the estimated picture.

The residual signal is spatially transformed through a (discrete cosine transform (DCT) process, a wavelet transform process, or similar such process, and then is transformed to produce coefficients. Then, the transformed coefficients are quantized to have predetermined intervals of quantizing step. By controlling the size of the quantizing step, it is possible to adjust the compression rate and image quality of output layer data. Trade-offs are made between the size of the quantizing step and the image quality. In general, as the size of the quantizing step becomes larger, the compression rate becomes higher and the image quality becomes lower. A result of the quantization, that is, the quantized coefficients and the motion vector are output from the base layer encoder 121.

A basic operation of the first enhancement layer encoder 122 is the same as that of the base layer encoder 121. However, the first enhancement layer encoder 122 is different from the base layer encoder 121 in that the first enhancement layer encoder 122 can more enhance the compression efficiency by using information in a lower layer, and the quantizing step used in the first enhancement layer encoder 122 is slightly smaller than that used in the base layer encoder 121.

In the same manner, the second enhancement layer encoder 123 and the (N−1)ₜₕ enhancement layer encoder 124 can also enhance the data compression efficiency by using the information in the lower layer (first enhancement layer).

The entropy coding unit 125 losslessly encodes the respective layer data created by the corresponding encoder for each layer so as to create a bitstream. Various coding methods, such as Huffman Coding, Arithmetic Coding, Variable Length Coding, or other similar method, may be used as the lossless coding method.

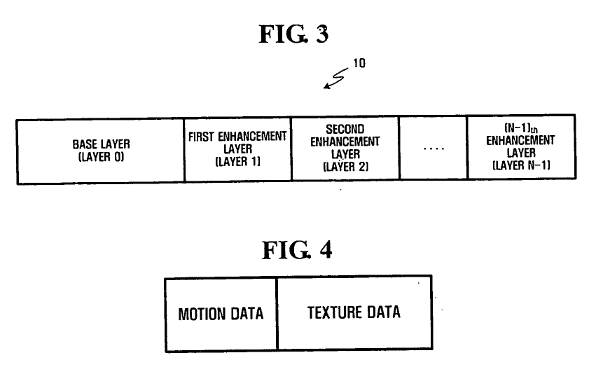

FIG. 3 is a view illustrating the configuration of a scalable bitstream 10 according to an exemplary embodiment of the present invention. The scalable bitstream 10 has a data structure composed of a plurality of layers. Assuming that a total of “N” layers exist, the scalable bitstream 10 has one base layer data and “N−1” enhancement layer data. The base layer may be denoted as 0 (layer 0). In general, the base layer data is independently created (encoded) without referring to other layers, but the enhancement layers are created after removing redundancy by referring to another layer (generally, the closest lower layer).

In FIG. 3, the respective layer data may include motion data and texture data, which are shown in FIG. 4. The motion data includes at least a motion vector created during a motion estimation process, and may further include a macro block pattern, the numbers of the reference pictures, and the like. The texture data is a result obtained by losslessly coding quantized coefficients output from the encoders corresponding to the respective layers.

In other words, referring to FIG. 1, the encrypting unit 130 encrypts the scalable bitstream by using the encryption key set created by the license generating unit 110 on the basis of a certain encryption algorithm. The certain encryption algorithm may be predetermined. As the encryption algorithm, it is possible to use any kind of conventional algorithms that perform an encrypting process by using the public key.

The encryption key set created by the license generating unit 110 includes “N” encryption keys (P₀ to P_{N-1}). Accordingly, the encrypting unit 130 encrypts respective layer data of the scalable bitstream 10, which is shown in FIG. 2, by using the “N” encryption keys. Here, the encryption key Pₖ (k is an integer, which may be predetermined) is used to encrypt layer data corresponding to a layer k.

The bitstream encrypted in the encrypting unit 130 is distributed to the various terminal devices 200 through a network 80. The network 80 is advantageously an Internet that can be easily accessible by the general public but is not limited thereto.

The license issuing server 300 issues a license, which includes the rules and encryption key set created by the license generating unit 110, in response to a terminal device and then charges a fee for the license. The license issuing server 300 is generally separated from the contents generating device 100. However, the license issuing server 300 may be formed integrally with the license generating unit 110 of the contents generating device 100.

Depending on the request and the fee charge, the license may include different rules or provide only a part of keys among a decryption key set corresponding to an encryption key set. The license according to an exemplary embodiment of the present invention is shown in table 1.

In the license shown in table 1, Rule is “1 time play”, Device ID used to identify whether or not a device is a specific device capable of using the license may be included, and contents information, such as Owner, Title, and Length, may be included. In particular, the license includes at least one decryption key that is used to decrypt corresponding layer data of the encrypted bitstream. In table 1, three decryption keys Q₀, Q₁, and Q₂ are included, and the three decryption keys Q₀, Q₁, and Q₂ are decryption keys capable of decrypting data in the base layer, the first enhancement layer, and the second enhancement layer encoder, respectively.

TABLE 1

| | |
|---|---|
| Rule | 1 time play |
| Device Info | Device ID |
| Key Info | Q₀ |
| | Q₁ |
| | Q₂ |
| Contents Info | Owner, Title, Length, etc. |

The contents playing device 200 is a terminal device that is connected to the contents generating device 100 through the network 80 and connected to the license issuing server 300 through a network 90. The contents playing device 200 denotes a device, such as a digital television (TV), a computer, a personal digital assistant (PDA), a mobile phone, or a portable multimedia player (PMP), which can be connected to a network and play back a video. The device may be predetermined. The network 90 may be the same kind of network as the network 80. However, unlike the network 80 that can be accessible by the general public, since the network 90 requires higher security than the network 80 when transmitting the license, it is advantageous if the network 90 is a network that can be guaranteed in terms of the security.

The contents playing device 200 includes a contents receiving unit 210, a license analysis unit 220, a decrypting unit 230, and a scalable video decoder 240.

The contents receiving unit 210 receives an encoded bitstream through the network 80 and stores the received encrypted bitstream in a storage unit. The storage unit may be predetermined. The contents receiving unit 210 has a receiving modem corresponding to the type of the network 80, and the modem may be implemented by an IEEE 802.3 Ethernet card, an IEEE 802.11 series receiving card, an IEEE 802.15.3 series receiving card, or similar modem. The storage unit may be implemented by a RAM 14, a flash memory, a hard disk, or various other storage media.

The license analysis unit 220 analyzes a license, such as the license shown in table 1, supplied from the license issuing server 300, and supplies a rule, denoted “Rule” in the figure, and a decryption key set Key_{Q} that are extracted as the above analysis result to the decrypting unit 230.

The decrypting unit 230 decrypts only layers corresponding to keys that are included in the decryption key set among layers of the encrypted bitstream and then supplies the decrypted bitstream to the scalable video decoder 240. In the case when an asymmetrical key method is used, the decryption key will be a secret key which forms a pair of keys together with an encryption key created by the contents generating device 100. On the other hand, in the case when a symmetrical key method is used, the decryption key will be the same key as the encryption key created by the contents generating device 100.

The decrypted bitstream may be the entire bitstream or a part of the bitstream according to the decryption key set. Further, the decrypting unit 230 periodically checks the rule “Rule” so as to determine whether or not the corresponding rule has expired. If the corresponding rule expires, the decrypting unit 230 stops supplying the bitstream to the scalable video decoder 240.

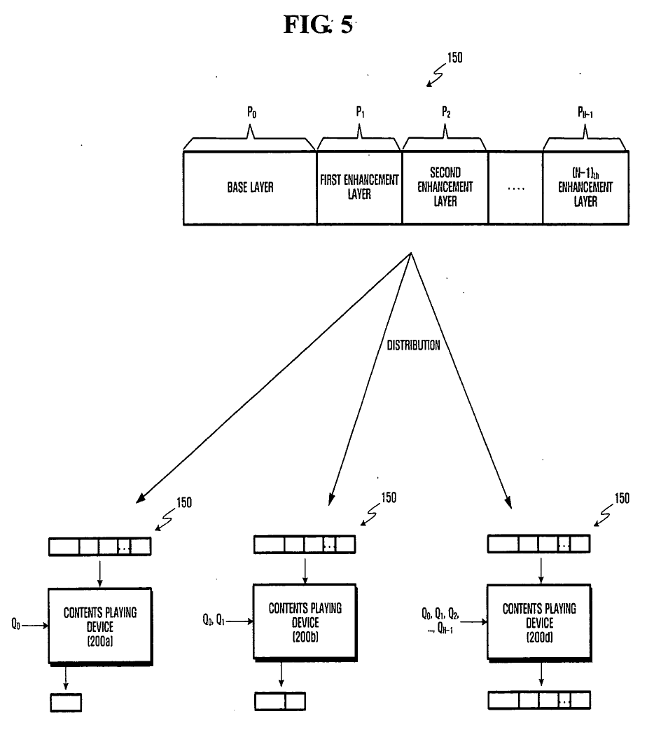

FIG. 5 is a view illustrating how a bitstream 150, which is encrypted by encryption keys P₀ to P_{N-1} for respective layers in the contents generating device 100, is decrypted by various contents playing devices 200a, 200b, and 200c. The contents playing device 200a, which has received the bitstream 150 encrypted for the respective layers, decrypts video data in a base layer (layer 0) because a decryption key included in the license is Q₀. In the case when the contents playing device 200a is a device that is insufficient in terms of a processing capability, resources, or a display capability, for example, like a mobile phone, only a license by which only the base layer can be decrypted may be occasionally enough.

Further, in the case of the contents playing device 200b, since decryption keys included in the license are Q₀ and Q₁, it is possible to decrypt video data in the base layer (layer 0) and the first enhancement layer (layer 1) by using the decryption keys Q₀ and Q₁. The contents playing device 200b can obtain a video having a quality corresponding to a level of the first enhancement layer by combining the base layer data and the first enhancement layer data that have been decrypted.

Furthermore, in the case of the contents playing device 200c, it is possible to obtain decryption keys Q₀ to Q_{N-1} with respect to all layer data and then decrypt the entire encrypted bitstream 150 by using the decryption keys Q₀ to Q_{N-1}. By combining the entire data that has been encrypted for the respective layers, it is possible to obtain a video having the (N−1) enhancement layer level, that is, the highest quality. In the case when the contents playing device 200c is a device that is sufficient in terms of the processing capability, the resources, or the display capability, for example, like a digital TV or a computer, a license by which all layers can be decrypted may be provided.

The entire bitstream or the part of the bitstream that has been decrypted by the decrypting unit 230 is supplied to the scalable video decoder 240, and then the entire bitstream or the part of the bitstream is output as a decoded video by means of the scalable video decoder 240.

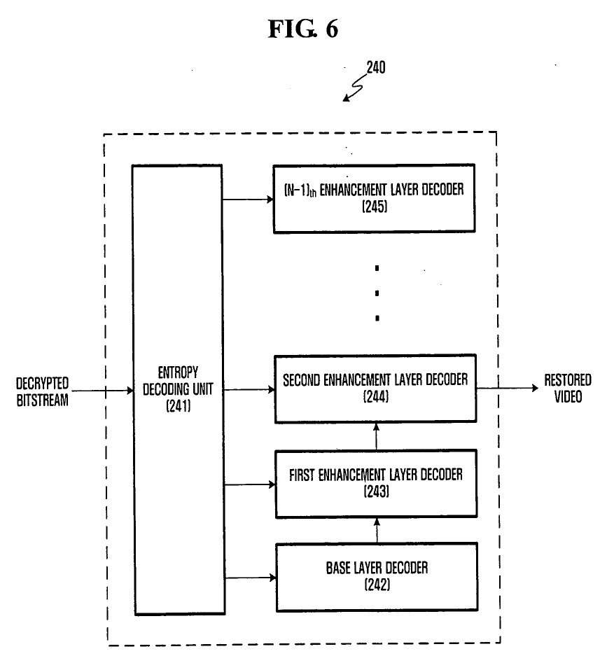

A detailed configuration of the scalable video decoder 240 is shown in FIG. 6.

An entropy decoding unit 241 performs a lossless decoding process for the decrypted bitstream so as to extract data for the respective layers and then supplies the extracted data to corresponding decoders 242 to 245. The data for the respective layers includes motion data and texture data shown in FIG. 4.

An operation performed by a base layer decoder 242 will be described.

First, the texture data is dequantized through a dequantizing process. The dequantizing process is a process inverse to the quantizing process performed by an encoder. That is, the dequantizing process is a process of decoding available coefficients from index-type quantized coefficients (quantization levels).

The decoded coefficients are inversely transformed through an inverse transform process, such as an inverse DCT process or an inverse wavelet transform process. As a result of the inverse transform, a residual signal with respect to the current picture is decoded.

Motion compensation for the reference pictures that have been already decoded is made by using a motion vector included in the motion data, thereby generating an estimation picture. Finally, a picture corresponding to a level of the base layer is decoded by adding the estimation picture and the residual signal. These pictures gather together so as to form one video.

A first enhancement layer decoder 243 is the same as the base layer decoder 242 in terms of a basic operation. However, the first enhancement layer decoder 243 is different from the base layer decoder 242 in that the first enhancement layer decoder 243 decodes a video corresponding to a level of the first enhancement layer by using information in a lower layer unlike the base layer decoder 242. In the same manner, a second enhancement layer decoder 244 can restore a video corresponding to a level of the second enhancement layer by using information in a lower layer (first enhancement layer).

As shown in the example of table 1, assuming that the contents playing device 200 has the three decryption keys Q₀, Q₁, and Q₂, an encrypted bitstream input to the scalable video decoder 240 includes a base layer, a first enhancement layer, and a second enhancement layer. Therefore, in this case, an output of the second enhancement layer decoder 244 will become a final video output.

The exemplary logic blocks described with reference to the exemplary embodiments may be realized or performed by using a general purpose processor designed to perform the functions described in this specification, a digital signal processor (DSP), an application specific integrated circuit (ASIC), a field programmable gate array (FPGA), a programmable logic unit, a discrete gate or a transistor logic unit, discrete hardware components, or similar component, or an arbitrary composition thereof. The general purpose processor may be a microprocessor. However, the general purpose processor may be, selectively, an arbitrary conventional processor, a controller, a microcontroller, or a state machine. Further, the general purpose processor may be realized by the composition of computing devices, for example, a composition of a DSP and a microprocessor, a plurality of microprocessors, at least one microprocessor related to a DSP core, or arbitrary another composition.

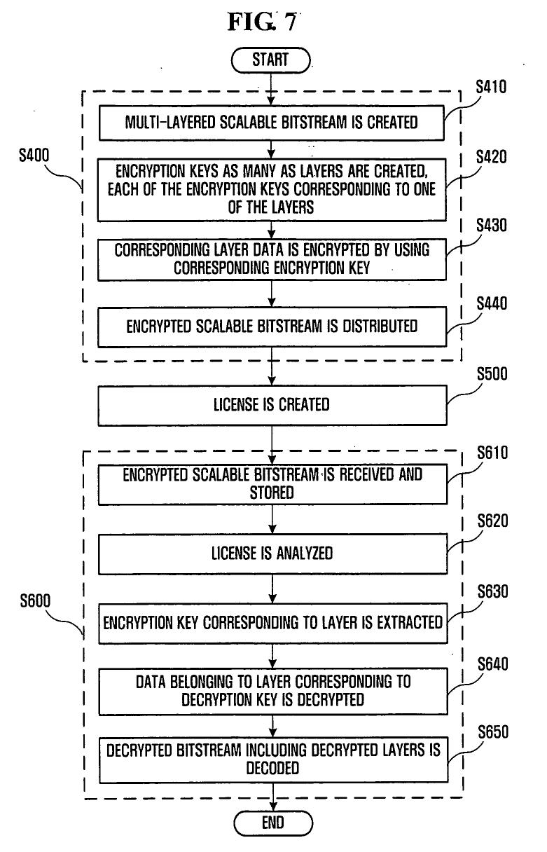

FIG. 7 is a flow chart illustrating overall operations of an exemplary embodiment of the present invention. First, an operation S400 performed by the contents generating device 100 will be described.

First, the scalable video encoder 120 generates a scalable bitstream, which has a plurality of layer data, by using an input video (S410). The plurality of layers may include a base layer and at least one enhancement layer, and data in one layer may include motion data and texture data.

The operation S410 may be divided into: a process of generating base layer data by down-sampling the input video with lowest resolution and/or frame rate and then encoding the down-sampled input video; and a process of generating enhancement layer data by down-sampling the input video with resolution and/or frame rate higher than the lowest resolution and/or frame rate and then encoding the down-sampled input video after removing redundancy between the down-sampled input video and the base layer data.

The license generating unit 110 generates encryption keys as many as the layers (S420). In the case when the encryption method is based on an asymmetrical key, the encryption keys may be public keys. Secret keys each forming a pair of keys together with the corresponding encryption key should also be created.

The encrypting unit 130 generates an encrypted scalable bitstream by encrypting layer data corresponding to each of the encryption keys by means of the corresponding encryption key (S430). The operation S400 may further include a process in which the license generating unit 110 generates rules to be applied to the entire multimedia data. The encrypted scalable bitstream may be distributed through a network accessible by the general public (S440).

The license issuing server 300 generates a license including the rules and the secret keys (S500) and supplies the license in response to a request of a content playing device and a subsequent fee charge. The license includes a field in which the rules are defined, a field in which device information is recorded, and a field in which key information on the secret keys is recorded.

An operation S600 performed by the contents playing device 200 will be described.

The contents receiving unit 210 receives and stores the encrypted scalable bitstream (S610). The receiving operation may be made through a network accessible by the general public.

The license analysis unit 220 analyzes a license issued by the license issuing server 300 (S620) and then extracts a decryption key corresponding to at least one layer included in the license (S630). The license may be predetermined. In the case when an encryption algorithm based on a public key is used, the decryption key corresponds to a secret key.

The decrypting unit 230 decrypts data, which belongs to a layer corresponding to the extracted decryption key, of the encrypted scalable bitstream by using the extracted decryption key (S640).

The scalable video decoder 240 decodes the decrypted bitstream including the decrypted layer (S650). The operation S650 may be divided into: a process of restoring a video corresponding to a level of the base layer by using data, which belongs to the base layer, of the decrypted bitstream; and a process of restoring a video corresponding to a level of an enhancement layer by using the video corresponding to the level of the base layer and data, which belongs to the enhancement layer, of the decrypted bitstream.

The operation S600 described above may further include a process of extracting rules included in the license by analyzing the license and a process of controlling the decrypting process on the basis of the rules.

Even though exemplary embodiments of the present invention have been described with respect to the multi-layered video stream, the present inventive concept can also be applied to an audio stream, a data stream, or various multimedia streams as long as a stream includes a plurality of layers and the redundancy between the plurality of layers is removed.

As described above, according to exemplary embodiments of the present invention, it is possible to use multimedia contents in more various ways by applying an encryption method suitable for a characteristic of a scalable bitstream.

Although the present inventive concept has been described in connection with exemplary embodiments of the present invention, it will be apparent to those skilled in the art that various modifications and changes may be made thereto without departing from the scope and spirit of the invention. Therefore, it should be understood that the above exemplary embodiments are not limiting, but illustrative in all aspects.

What is claimed is:

1. A method of encrypting multi-layered multimedia data by layers, comprising:
generating a scalable bitstream from an input video, the scalable bitstream having a plurality of layers of data;
generating a plurality of encryption keys for the plurality of layers; and
generating an encrypted scalable bitstream by encrypting each layer of data by means of the encryption key corresponding to the layer.

2. The method of claim 1, further comprising generating rules that are applied to the entire data.

3. The method of claim 1, further comprising generating a plurality of secret keys, each of the secret keys and a corresponding one of the encryption keys forming a pair of keys, wherein the encryption keys are public keys.

4. The method of claim 1, wherein the plurality of layers comprise a base layer and at least one enhancement layer.

5. The method of claim 1, wherein the data comprises motion data and texture data.

6. The method of claim 1, wherein the generating of the scalable bitstream comprises:
generating base layer data by down-sampling the input video with a lowest resolution or frame rate;
encoding the down-sampled input video;
generating enhancement layer data by down-sampling the input video with a resolution or frame rate higher than the lowest resolution or frame rate; and
removing redundancy between the down-sampled input video and the base layer data; and
encoding the down-sampled input video.

7. The method of claim 3, further comprising generating a license including rules and the secret keys, wherein the license comprises a field in which the rules are defined, a field in which device information is recorded, and a field in which key information on the secret keys is recorded.

8. A method of decrypting data by layers, comprising:
receiving an encrypted scalable bitstream;
analyzing a license so as to extract a decryption key corresponding to at least one layer included in the license;
decrypting data, which belongs to a layer corresponding to the extracted decryption key, of the encrypted scalable bitstream using the extracted decryption key; and
decoding the decrypted bitstream including the decrypted layers.

9. The method of claim 8, wherein the encrypted scalable bitstream is received through a network accessible by the general public.

10. The method of claim 8, wherein the decryption key corresponds to a secret key in an encryption algorithm based on a public key.

11. The method of claim 8, wherein the plurality of layers comprise a base layer and at least one enhancement layer.

12. The method of claim 8, further comprising receiving the license from a license issuing server through a network.

13. The method of claim 12, wherein the license comprises a field in which rules are defined, a field in which device information is recorded, and a field in which key information on the decryption keys is recorded.

14. The method of claim 8, further comprising analyzing the license so as to extract rules included in the license, and controlling the decrypting of the data on the basis of the rules.

15. The method of claim 8, wherein the decoding of the decrypted bitstream comprises:
decoding a video corresponding to a level of a base layer by using base layer data of the decrypted bitstream; and
decoding a video corresponding to a level of an enhanced level by using the video corresponding to the level of the base layer and enhancement layer data of the decrypted bitstream.

16. An apparatus for encrypting data by layers, the apparatus comprising:
a scalable video encoder which generates a scalable bitstream by using an input video, the scalable bitstream having a plurality of layer data;
a license generating unit which generates a plurality of encryption keys, each of the encryption keys corresponding to a respective one of the plurality of layers; and
an encrypting unit which generates an encrypted scalable bitstream by encrypting the layer data corresponding to the respective encryption keys by means of the corresponding encryption keys.

17. An apparatus for decrypting data by layers, the apparatus comprising:
a contents receiving unit which receives an encrypted scalable bitstream;
a license analysis unit which analyzes a license so as to extract a decryption key corresponding to at least one layer included in the license;
a decrypting unit which decrypts data, which belongs to a layer corresponding to the extracted decryption key, of the encrypted scalable bitstream using the extracted decryption key; and
a scalable video decoder which decodes the decrypted bitstream including the decrypted layer.
